(19) United States
(12) Patent Application Publication
(10) Pub. No.: US 2022/0269363 A1
(43) Pub. Date: Aug. 25, 2022

(54) TOUCH DISPLAY PANEL AND DISPLAY DEVICE

(71) Applicants: Hefei BOE Optoelectronics Technology Co., Ltd., Hefei (CN); BOE Technology Group Co., Ltd., Beijing (CN)

(72) Inventors: Chengwei LI, Beijing (CN); Dayu ZHANG, Beijing (CN); Zhiwei ZHANG, Beijing (CN); Taorong WANG, Beijing (CN)

(21) Appl. No.: 17/497,921

(22) Filed: Oct. 9, 2021

(30) Foreign Application Priority Data
Feb. 25, 2021 (CN) 202110210510.1

(51) Int. Cl. G06F 3/041; G06F 3/044

(52) U.S. Cl. CPC G06F 3/0412; G06F 3/0443; G06F 3/04164

(57) ABSTRACT

Embodiments of the present disclosure disclose a touch display panel and a display device. Two touch electrode routing wires are arranged correspondingly between two adjacent data lines, a distance between the two touch electrode routing wires between the two adjacent data lines is smaller than each of distances from the touch electrode routing wires to the data lines correspondingly adjacent thereto, and the distances from the two touch electrode routing wires between the two adjacent data lines to the data lines correspondingly adjacent thereto are unequal.

### CROSS REFERENCE TO RELATED APPLICATIONS

The present disclosure claims priority to Chinese Patent Application No. 202110210510.1, filed with the China National Intellectual Property Administration on Feb. 25, 2021, the content of which is incorporated herein by reference in its entirety.

### FIELD

The present disclosure relates to the technical field of touch display, and particularly to a touch display panel and a display device.

### BACKGROUND

In an existing design of a self-capacitance in-cell touch display device, touch electrodes are generally blocky and multiplexed with common electrodes, the touch electrodes are connected with a touch signal output end of a driving circuit through touch electrode routing wires, and each of the touch electrodes corresponds to one of the touch electrode routing wires connected therewith. In a display period, the driving circuit inputs a common voltage signal into the touch electrodes through the touch electrode routing wires, and in a touch period, a touch signal is input into the touch electrodes through the touch electrode routing wires. A plurality of pixel units are arranged in a region where the touch electrodes are located, each of the pixel units includes three sub-pixel units which are a red (R) sub-pixel unit, a green (G) sub-pixel unit and a blue (B) sub-pixel unit, and the touch electrode routing wires corresponding to the touch electrodes are generally arranged on a side of a column of pixel units in the touch electrodes. The touch electrode routing wires are arranged on a side of only one column of pixel units, no touch electrode routing wire is arranged in other columns of pixel units at the same positions as the only one column of pixel units, so that distribution of the touch electrode routing wires is non-uniform, and consequently, the displaying uniformity of the touch display device is poor during displaying and touching.

### SUMMARY

The present disclosure provides a touch display panel and a display device.

An embodiment of the present disclosure provides a touch display panel, including a display substrate and a plurality of touch units, where the display substrate includes: a base substrate, a plurality of rows and columns of sub-pixel units located on the base substrate, a plurality of data lines each of which being electrically connected with a column of sub-pixel units in a one-to-one correspondence, and a plurality of touch electrode routing wires each of which being electrically connected with one of the touch units in a one-to-one correspondence; each of the touch units includes a plurality of touch electrode blocks electrically connected with one another; and two touch electrode routing wires are arranged correspondingly between two adjacent data lines, a distance between the two touch electrode routing wires between the two adjacent data lines is smaller than each of distances from the touch electrode routing wires to the data lines correspondingly adjacent thereto, and the distances from the two touch electrode routing wires between the two adjacent data lines to the data lines correspondingly adjacent thereto are unequal.

An embodiment of the present disclosure further provides a display device, including the above touch display panel provided by an embodiment of the present disclosure.

### BRIEF DESCRIPTION OF THE DRAWINGS

FIG. 1 is a schematic top view of a touch display panel provided by an embodiment of the present disclosure.

FIG. 2 is a layout of some regions in FIG. 1.

FIG. 3 is a schematic top view of another touch display panel provided by an embodiment of the present disclosure.

FIG. 4 is a layout of some regions in FIG. 3.

### DETAILED DESCRIPTION

In order to make objectives, technical solutions and advantages of embodiments of the present disclosure clearer, the technical solutions of embodiments of the present disclosure will be clearly and fully described in combination with the accompanying drawings of embodiments of the present disclosure. Apparently, the described embodiments are only some, but not all of embodiments of the present disclosure. Embodiments and features in embodiments of the present disclosure can be mutually combined under the condition of no conflict. Based on the described embodiments of the present disclosure, all other embodiments obtained by those ordinarily skilled in the art without creative work belong to the protection scope of the present disclosure.

Unless otherwise defined, technical or scientific terms used herein should be understood commonly by those ordinarily skilled in the art of the present disclosure. “Include”, “contain” and other similar words used herein mean that components or items preceding the word cover components or items and their equivalents listed after the word without excluding other components or items. “Connection”, “connected to” and other similar words may include electrical connection, direct or indirect, instead of being limited to physical or mechanical connection. “Inner”, “outer”, “upper”, “lower” and the like are only used for denoting a relative positional relationship, and when an absolute position of a described object changes, the relative positional relationship may change correspondingly.

It should be noted that sizes and shapes of all figures in the drawings do not reflect a true scale and are only intended to illustrate contents of the present disclosure. Same or similar reference numbers denote same or similar components or components with same or similar function all the time.

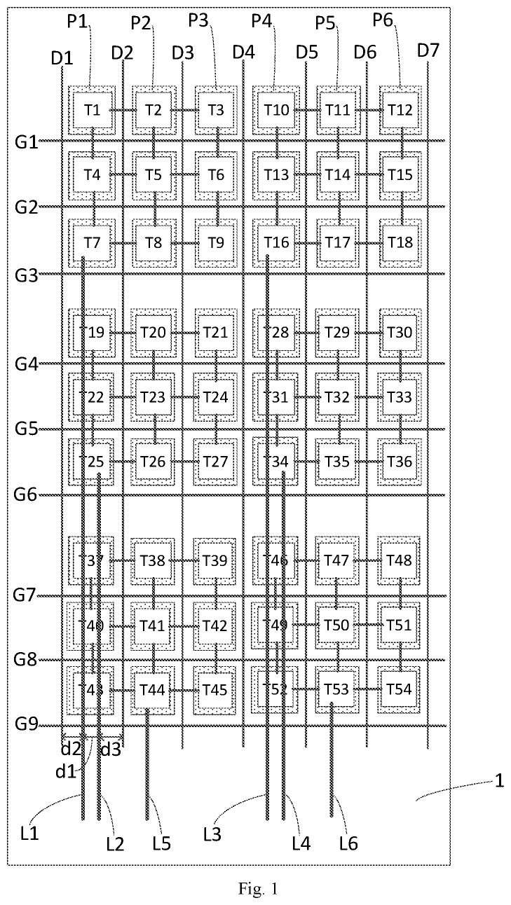

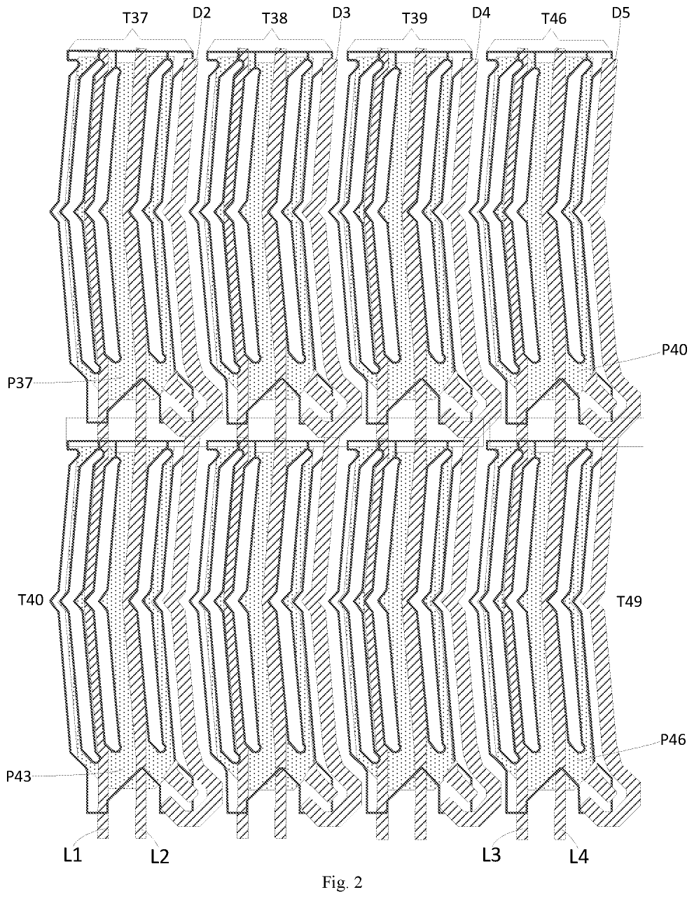

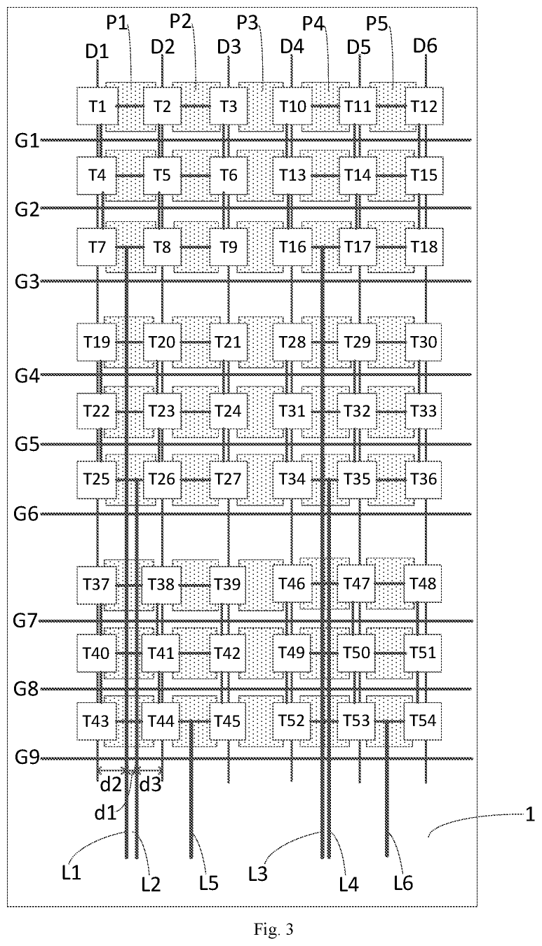

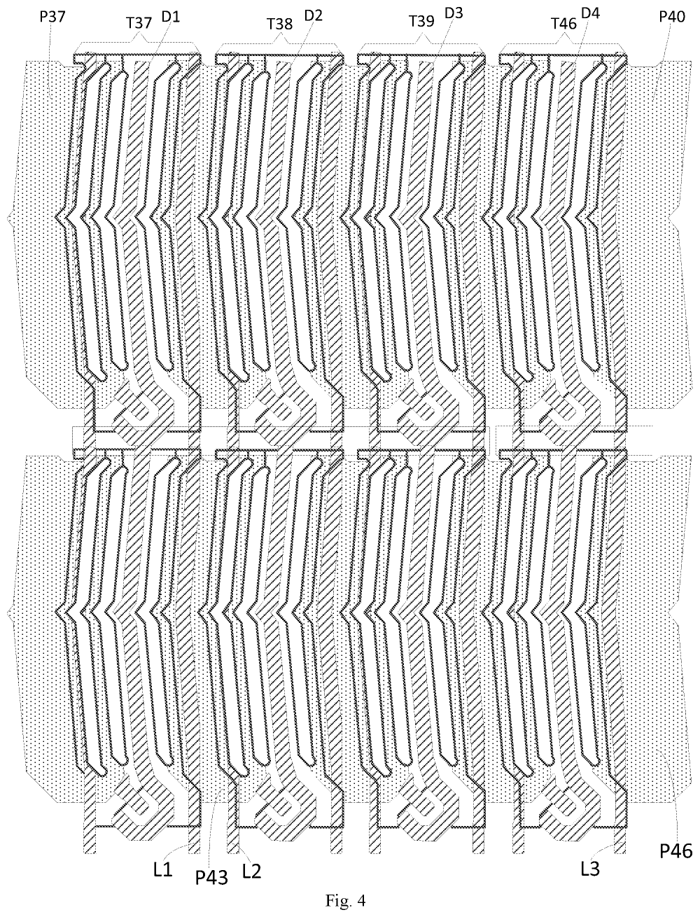

An embodiment of the present disclosure provides a touch display panel, as shown in FIG. 1 to FIG. 4. Each of FIG. 1 and FIG. 3 is a schematic top view of a touch display panel, FIG. 2 is a layout of some regions in FIG. 1, and FIG. 4 is a layout of some regions in FIG. 3. The touch display panel includes a display substrate and a plurality of touch units. The display substrate includes: a base substrate 1, a plurality of rows and columns of sub-pixel units (P1, P2, P3 . . . ) located on the base substrate 1, a plurality of data lines (D1, D2, D3 . . . ) each of which being electrically connected with a column of sub-pixel units in a one-to-one correspondence, and a plurality of touch electrode routing wires (L1, L2, L3 . . . ) each of which being electrically connected with one of the touch units in a one-to-one correspondence. Each of the touch units includes a plurality of touch electrode blocks electrically connected with one another. Taking six touch units, each of the touch units includes nine touch electrode blocks in FIG. 1 for example, the first touch unit includes touch electrode blocks T1-T9, the second touch units includes nine touch electrode blocks T10-T18, the third touch unit includes nine touch electrode blocks T19-T27, the fourth touch unit includes nine touch electrode blocks T28-T36, the fifth touch unit includes nine touch electrode blocks T37-T45, and the sixth touch unit includes nine touch electrode blocks T46-T54. Two touch electrode routing wires are arranged correspondingly between two adjacent data lines, for example, the two touch electrode routing wires L1 and L2 are arranged between the adjacent data line D1 and data line D2, L1 is electrically connected with the first touch unit to lead to a peripheral driving circuit (not shown), and L2 is electrically connected with the third touch unit to lead to the peripheral driving circuit. Two touch electrode routing wires L3 and L4 are arranged between the adjacent data line D4 and data line D5, L3 is electrically connected with the second touch unit to lead to the peripheral driving circuit, and L4 is electrically connected with the fourth touch unit to lead to the peripheral driving circuit, and so on. A distance between the two touch electrode routing wires between the two adjacent data lines is smaller than each of distances from the touch electrode routing wires to the data lines correspondingly adjacent thereto, for example, a distance d1 between the two touch electrode routing wires L1 and L2 between the adjacent data line D1 and data line D2 is smaller than a distance d2 from the touch electrode routing wire L1 to the data line D1 adjacent thereto. Distances from the two touch electrode routing wires between two adjacent data lines to the data lines correspondingly adjacent thereto are unequal, for example, the distance d2 from the touch electrode routing wire L1 between the adjacent data line D1 and data line D2 to the data line D1 adjacent to the touch electrode routing wire L1 is unequal to a distance d3 from the touch electrode routing wire L2 to the data line D2 adjacent to the touch electrode routing wire L2.

According to the touch display panel provided by an embodiment of the present disclosure, two touch electrode routing wires are arranged correspondingly between two adjacent data lines, the distance between the two touch electrode routing wires between the two adjacent data lines is smaller than each of the distances from the touch electrode routing wires and the data lines correspondingly adjacent thereto, the distances from the two touch electrode routing wires between the two adjacent data lines to the data lines correspondingly adjacent thereto are unequal, thus all the touch electrode routing wires may be distributed in a region where the touch electrodes are located as uniformly as possible, the problem of non-uniform distribution of the touch electrode routing wires is solved, and the touching and displaying uniformity of a display device including the touch display panel is improved. Besides, the touch electrode blocks in the same row are mutually spaced, and the touch electrode blocks in the same column are mutually spaced, so that the touch electrode blocks are distributed uniformly.

In an embodiment of the present disclosure, the display substrate may be but not limited to an array substrate.

In an embodiment of the present disclosure, as shown in FIG. 1, grid lines (G1, G2, G3 . . . ) interlaced with the data lines (D1, D2, D3 . . . ) are further arranged on the array substrate. The plurality of rows and columns of sub-pixel units (P1, P2, P3 . . . ) are defined by the grid lines (G1, G2, G3 . . . ) and the data lines (D1, D2, D3 . . . ).

In some embodiments, the touch electrode blocks may be but not limited to capacitance blocks.

In some embodiments, the sub-pixel units may include but are not limited to a red (R) sub-pixel unit, a green (G) sub-pixel unit and a blue (B) sub-pixel unit.

In some embodiments, as shown in FIG. 1 and FIG. 3, shapes and sizes of all the touch electrode blocks included in each of the touch units may be identical, and the sizes of the touch electrode blocks may be not larger than those of the corresponding sub-pixel units, which is not limited herein. In an embodiment of the present disclosure, FIG. 1 and FIG. 3 make illustrations by taking the touch electrode blocks being regular square blocks for example, however, during actual fabrication, the shape of each of the touch electrode block is irregular, as shown in FIG. 2 and FIG. 4. FIG. 2 and FIG. 4 each show 8 touch electrode blocks (shown in braces), FIG. 2 and FIG. 4 are schematic layout diagrams close to an actual fabrication process, and it can be seen that the touch electrode blocks are irregular.

In some embodiments, in the touch display panel provided by an embodiment of the present disclosure, as shown in FIG. 1 and FIG. 2, orthographic projections of the data lines (D1, D2, D3 . . . ) on the base substrate 1 do not overlap with orthographic projections of the touch electrode blocks (T1-T54) on the base substrate 1. Thus, in a touch stage, coupling capacitance does not exist between the touch electrode blocks and the data lines, and the response speed of touching and displaying is improved.

In some embodiments, in the touch display panel provided by an embodiment of the present disclosure, as shown in FIG. 1 and FIG. 2, an orthographic projection of each of the touch electrode blocks on the base substrate is located in an orthographic projection of a corresponding sub-pixel unit on the base substrate, for example, the orthographic projection of the touch electrode block T1 on the base substrate 1 is located in the orthographic projection of the corresponding sub-pixel unit P1 on the base substrate 1, the orthographic projection of the touch electrode block T2 on the base substrate 1 is located in the orthographic projection of the corresponding sub-pixel unit P2 on the base substrate 1, the orthographic projection of the touch electrode block T3 on the base substrate 1 is located in the orthographic projection of the corresponding sub-pixel unit P3 on the base substrate 1, and so on. Further, the orthographic projections of the touch electrode blocks on the base substrate do not overlap with the orthographic projections of the data lines on the base substrate, thus in the touch stage, the coupling capacitance does not exist between the touch electrode blocks and the data lines, and the response speed of touching and displaying is further improved.

In some embodiments, in the touch display panel provided by an embodiment of the present disclosure, as shown in FIG. 1 and FIG. 2, the touch electrode blocks are in a one-to-one correspondence with the sub-pixel units, for example, T1 corresponds to P1, T2 corresponds to P2, T3 corresponds to P3, and so on. The sub-pixel unit (e.g., P1) includes a pixel electrode (not shown) electrically connected with the data line D2, and the orthographic projection of the touch electrode block T1 on the base substrate 1 is located in an orthographic projection of the corresponding pixel electrode on the base substrate 1. Thus, the touch electrode blocks may be distributed uniformly, and the uniformity of touching and displaying of the touch display panel is further improved.

In some embodiments, in the touch display panel provided by an embodiment of the present disclosure, as shown in FIG. 1 and FIG. 2, an orthographic projection of the touch electrode routing wire (e.g., L1) on the base substrate 1 overlaps with the orthographic projections of the touch electrode blocks (the first column of touch electrode blocks on the left) on the base substrate 1.

In some embodiments, in the touch display panel provided by an embodiment of the present disclosure, as shown in FIG. 3 and FIG. 4, the orthographic projections of the data lines (D1, D2, D3 . . . ) on the base substrate 1 may overlap with the orthographic projections of the touch electrode blocks (T1-T54) on the base substrate 1.

In some embodiments, in the touch display panel provided by an embodiment of the present disclosure, as shown in FIG. 3 and FIG. 4, each sub-pixel unit (e.g., P1) includes a pixel electrode (not shown) electrically connected with the data line D2, and an orthographic projection of the pixel electrode (e.g., the pixel electrode in P1) on the base substrate 1 and each of the orthographic projections of two touch electrode blocks (T1 and T2) on the base substrate 1 have an overlapping region. In this way, an orthographic projection of each of the touch electrode routing wires on the base substrate 1 may be located at a gap between two adjacent columns of touch electrode blocks. Thus, in some embodiments, in the touch display panel provided by an embodiment of the present disclosure, as shown in FIG. 3, the orthographic projection of the touch electrode routing wire (e.g., L5) on the base substrate L1 is located at the gap between the two adjacent columns of touch electrode blocks (the second column and the third column on the left). Thus, in the touch stage, the coupling capacitance does not exist between the touch electrode blocks and the touch electrode routing wires, and the response speed of touching and displaying is further improved.

In some embodiments, in the touch display panel provided by an embodiment of the present disclosure, as shown in FIG. 2 and FIG. 4, the touch electrode routing wires (L1, L2, L3, L4 . . . ) and the data lines (D1, D2, D3, D4, D5 . . . ) are arranged on a same layer. The touch electrode routing wires and the data lines adopt a same filling pattern, which mean that they are located on a same layer. The touch electrode routing wires and the data lines may be designed side by side. Thus, only by changing an original pattern when forming the data lines, patterns of the touch electrode routing wires and the data lines may be formed through a one-time pattern forming process, a process of independently fabricating the touch electrode routing wires is not needed, a fabrication process flow may be simplified, the production cost is reduced, and the production efficiency is improved.

In some embodiments, the touch units are arranged on a layer above the data lines, namely, the touch units and the data lines are located on different layers, and in this way, the touch units and the touch electrode routing wires are in lap joint through via holes.

In some embodiments, the touch display panel provided by an embodiment of the present disclosure further includes a common electrode layer. The common electrode layer includes a plurality of common electrode blocks which are multiplexed as the touch electrode blocks shown in FIG. 1 and FIG. 3. Thus, the process of independently fabricating the touch electrode blocks is not needed, a thickness of the touch display panel may be reduced, the production cost is reduced, and the production efficiency is improved.

In some embodiments, the touch units load a common voltage signal in a display period and load a touch signal in a touch period, so that the touch display panel with integrated touching and displaying is realized. Namely, the touch electrodes and the common electrode are multiplexed.

In an embodiment of the present disclosure, the touch electrode blocks may be self-capacitance touch electrodes, or mutual-capacitance touch electrodes. The touch electrode blocks may serve as touch driving electrodes of the mutual-capacitance touch electrodes when the touch electrode blocks are the mutual-capacitance touch electrodes.

In some embodiments, in the touch display panel provided by an embodiment of the present disclosure, as shown in FIG. 1 and FIG. 3, the common electrode layer further includes connection electrodes, and the touch electrode blocks in each of the touch units are electrically connected through the connection electrodes. For example, the nine touch electrode blocks T1-T9 in the first touch unit are electrically connected with one another through the connection electrodes.

In some embodiments, in the touch display panel provided by an embodiment of the present disclosure, as shown in FIG. 1 and FIG. 3, among all the touch electrode blocks in each of the touch units, the touch electrode blocks arranged in a row direction are electrically connected in pairs respectively through corresponding connection electrodes, and the touch electrode blocks arranged in a column direction are electrically connected in pairs respectively through corresponding connection electrodes. The connection electrodes may affect touching and displaying, so that an arrangement mode of the connection electrodes in the present disclosure may guarantee that the connection electrodes are uniformly distributed in the touch display panel, and the uniformity of displaying and touching is further improved.

In some embodiments, in the touch display panel provided by an embodiment of the present disclosure, as shown in FIG. 1 and FIG. 3, the plurality of touch units are arranged, and only six touch units are illustrated in the present disclosure. In some embodiments, the quantity of the touch units is far more than six. Each of the touch units has a same quantity of touch electrode blocks. An embodiment of the present disclosure takes each of the touch units including but not limited to nine touch electrode blocks for example, by means of the arrangement mode, the touch electrode blocks are distributed quite uniformly, and the uniformity of touching and displaying is further improved.

In some embodiments, in the touch display panel provided by an embodiment of the present disclosure, each of the touch units may include M×N touch electrode blocks, where each of M and N is a natural number larger than or equal to 2.

For example, lengths of the touch units may correspond to three sub-pixel units in a row direction and correspond to three sub-pixel units in a column direction. The lengths of the touch units may correspond to six sub-pixel units in the row direction and correspond to three sub-pixel units in the column direction. The quantity of the sub-pixel units corresponding to the touch units in the row direction and in the column direction is not limited and is designed according to actual demands.

It needs to be noted that the touch display panel provided by an embodiment of the present disclosure may be applied to a liquid crystal display (LCD) panel, or an organic light-emitting diode (OLED) display panel, or other display panels, which is not limited herein.

The arrangement mode of the touch electrode routing wires in the touch display panel provided by an embodiment of the present disclosure greatly improves the response speed and the uniformity of touching and displaying, for example, it is of great significance to a MPP 2.0 and 2 mm passive stylus and higher demands.

Based on the same inventive concept, an embodiment of the present disclosure further provides a display device, including the above touch display panel provided by an embodiment of the present disclosure. The display device may be: a mobile phone, a tablet PC, a TV, a display, a laptop, a digital photo frame, a navigator and any other product or parts with a displaying function. Other essential components of the display device should be understood by those ordinarily skilled in the art and will be neither detailed herein nor supposed to limit the present disclosure. A principle of solving problems of the display device is similar to that of the aforementioned touch display panel, and therefore implementation of the display device may be referred to implementation of the aforementioned touch display panel, and repetitions are omitted herein.

According to the touch display panel and the display device provided by embodiments of the present disclosure, two touch electrode routing wires are arranged correspondingly between two adjacent data lines, the distance between the two touch electrode routing wires between the two adjacent data lines is smaller than each of the distances from the touch electrode routing wires to the data lines correspondingly adjacent thereto, and the distances from the two touch electrode routing wires between the two adjacent data lines to the data lines correspondingly adjacent thereto are unequal, so that all the touch electrode routing wires may be distributed in the region where the touch electrodes are located as uniformly as possible, the problem of non-uniform distribution of the touch electrode routing wires is solved, and the uniformity of touching and displaying of the display device including the touch display panel is improved. Besides, the touch electrode blocks in the same row are mutually spaced, and the touch electrode blocks in the same column are mutually spaced, so that the touch electrode blocks are distributed uniformly.

Though embodiments of the present disclosure are already described, those skilled in the art can make extra changes and modifications for these embodiments once they know the basic inventive concept. Thus, the appended claims intend to be constructed as including embodiments and all the changes and modifications in the scope of the present disclosure.

Apparently, those skilled in the art can make various changes and modifications for embodiments of the present disclosure without departing from the spirit and scope of embodiments of the present disclosure. In this case, if these changes and modifications of embodiments of the present disclosure fall in the scope of the claims and their equivalents, the present disclosure also intends to include these changes and modifications.

What is claimed is:

1. A touch display panel, comprising a display substrate and a plurality of touch units, wherein the display substrate comprises: a base substrate, a plurality of rows and columns of sub-pixel units located on the base substrate, a plurality of data lines each of which being electrically connected with a column of sub-pixel units in a one-to-one correspondence, and a plurality of touch electrode routing wires each of which being electrically connected with one of the touch units in a one-to-one correspondence; each of the touch units comprises a plurality of touch electrode blocks electrically connected with one another; and two touch electrode routing wires are arranged correspondingly between two adjacent data lines, a distance between the two touch electrode routing wires between the two adjacent data lines is smaller than each of distances from the touch electrode routing wires to the data lines correspondingly adjacent thereto, and the distances from the two touch electrode routing wires between the two adjacent data lines to the data lines correspondingly adjacent thereto are unequal.

2. The touch display panel according to claim 1, wherein orthographic projections of the data lines on the base substrate do not overlap with orthographic projections of the touch electrode blocks on the base substrate.

3. The touch display panel according to claim 2, wherein an orthographic projection of each of the touch electrode blocks on the base substrate is located in an orthographic projection of a corresponding sub-pixel unit on the base substrate.

4. The touch display panel according to claim 3, wherein the touch electrode blocks are in a one-to-one correspondence with the sub-pixel units, each of the sub-pixel units comprises a pixel electrode electrically connected with one of the data lines, and the orthographic projection of each of the touch electrode blocks on the base substrate is located in an orthographic projection of a corresponding pixel electrode on the base substrate.

5. The touch display panel according to claim 2, wherein orthographic projections of the touch electrode routing wires on the base substrate overlap with the orthographic projections of the touch electrode blocks on the base substrate.

6. The touch display panel according to claim 1, wherein orthographic projections of the data lines on the base substrate overlap with orthographic projections of the touch electrode blocks on the base substrate.

7. The touch display panel according to claim 6, wherein each of the sub-pixel units comprises a pixel electrode electrically connected with one of the data lines, and an orthographic projection of the pixel electrode on the base substrate and each of the orthographic projections of two touch electrode blocks on the base substrate have an overlapping region.

8. The touch display panel according to claim 6, wherein an orthographic projection of each of the touch electrode routing wires on the base substrate is located at a gap between two adjacent columns of touch electrode blocks.

9. The touch display panel according to claim 1, wherein the touch electrode routing wires and the data lines are arranged on a same layer.

10. The touch display panel according to claim 1, further comprising a common electrode layer, wherein the common electrode layer comprises a plurality of common electrode blocks, and the common electrode blocks are multiplexed as the touch electrode blocks.

11. The touch display panel according to claim 10, wherein the common electrode layer further comprises connection electrodes, and the touch electrode blocks in each of the touch units are electrically connected through the connection electrodes.

12. The touch display panel according to claim 11, wherein among all the touch electrode blocks in each of the touch units, the touch electrode blocks arranged in a row direction are electrically connected in pairs respectively through corresponding connection electrodes, and the touch electrode blocks arranged in a column direction are electrically connected in pairs respectively through corresponding connection electrodes.

13. The touch display panel according to claim 1, wherein the plurality of touch units are arranged, and each of the touch units has a same quantity of touch electrode blocks.

14. The touch display panel according to claim 13, wherein each of the touch units comprises M×N touch electrode blocks, and each of M and N is a natural number larger than or equal to 2.

15. A display device, comprising a touch display panel, wherein the display panel comprises a display substrate and a plurality of touch units, and the display substrate comprises: a base substrate, a plurality of rows and columns of sub-pixel units located on the base substrate, a plurality of data lines each of which being electrically connected with a column of the sub-pixel units in a one-to-one correspondence, and a plurality of touch electrode routing wires each of which being electrically connected with one of the touch units in a one-to-one correspondence; each of the touch units comprises a plurality of touch electrode blocks electrically connected with one another; and two touch electrode routing wires are arranged correspondingly between two adjacent data lines, a distance between the two touch electrode routing wires between the two adjacent data lines is smaller than each of distances from the touch electrode routing wires and the data lines correspondingly adjacent thereto, and the distances from the two touch electrode routing wires between the two adjacent data lines to the data lines correspondingly adjacent thereto are unequal.

16. The display device according to claim 15, wherein orthographic projections of the data lines on the base substrate do not overlap with orthographic projections of the touch electrode blocks on the base substrate.

17. The display device according to claim 16, wherein an orthographic projection of each of the touch electrode blocks on the base substrate is located in an orthographic projection of a corresponding sub-pixel unit on the base substrate.

18. The display device according to claim 17, wherein the touch electrode blocks are in a one-to-one correspondence with the sub-pixel units, each of the sub-pixel units comprises a pixel electrode electrically connected with one of the data lines, and the orthographic projection of each of the touch electrode blocks on the base substrate is located in an orthographic projection of a corresponding pixel electrode on the base substrate.

19. The display device according to claim 16, wherein orthographic projections of the touch electrode routing wires on the base substrate overlap with the orthographic projections of the touch electrode blocks on the base substrate.

20. The display device according to claim 15, wherein orthographic projections of the data lines on the base substrate overlap with orthographic projections of the touch electrode blocks on the base substrate.
